(19) United States
(12) Patent Application Publication
(10) Pub. No.: US 2008/0079720 A1
(43) Pub. Date: Apr. 3, 2008

(54) Method, medium, and system authoring three-dimensional graphic data

(75) Inventors: Se-yoon Tak, Anyang-si (KR); Sang-oak Woo, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/889,321

(22) Filed: Aug. 10, 2007

(30) Foreign Application Priority Data
Sep. 28, 2006 (KR) 10-2006-0095038

(51) Int. Cl. G06T 15/00

(52) U.S. Cl. 345/419

(57) ABSTRACT

A method, medium, and system authoring 3D (three-dimensional) graphic data. In the method, a rendering function corresponding to characteristics of an authored object is generated. It is determined whether the total number of rendering functions including the generated rendering function exceeds a predetermined number. The object is re-authored to correspond to one of the total number of rendering functions according to results of the determining. When 3D graphic data is reproduced, the number of rendering functions being used can be limited, and thus, a reduction in rendering performance during the authoring phase can be prevented.

### CROSS-REFERENCE TO RELATED APPLICATIONS

This application claims the benefit of Korean Patent Application No. 10-2006-0095038, filed on Sep. 28, 2006, in the Korean Intellectual Property Office, the disclosure of which is incorporated herein in its entirety by reference.

### BACKGROUND OF THE INVENTION

1. Field of the Invention

One or more embodiments of the present invention relate to a method, medium, and system authoring three-dimensional (3D) graphic data.

2. Description of the Related Art

Techniques of describing 3D graphic data in order to represent 3D objects on two-dimensional (2D) screens typically include standard virtual reality modeling language (VRML). Such 3D graphic data can include geometric data on objects in a 3-dimensional space, data on the material composition of the objects, and data on changes in the objects over time. For example, the geometric data may include the positions of the 3D vertices forming an object and data on the connections between the vertices and the material composition data may include the texture, transparency, color, and surface reflectivity of an object, and the characteristics of an object according to the positions of light sources.

Accordingly, devices for reading this 3D graphic data, interpreting the meaning of the 3D graphic data so as to be output to a display, and converting the data are desired. Such a 3D device is conventionally a 3D graphics rendering engine, which can include a parser and a renderer, for example. The parser reads and interprets 3D graphic data. That is, the parser performs the discerning, interpreting, and determining of whether the read data is geometric data of objects, material composition data of objects, or whether there is a dependant relationship between objects based on a scene graph structure. The renderer renders a scene graph corresponding to the results interpreted by the parser, and outputs the rendered scene graph, e.g., to a display.

However, a conventional rendering engine includes one rendering function having all codes that can process 3D data. Conventional rendering engines do not take into account the characteristics of 3D graphic data, while using a fixed rendering function to render all graphic data in the same manner, resulting in there being a substantial amount different codes that perform unnecessary functions. Thus, the size of the rendering function increases unnecessarily. Here, when the size of a rendering function increases, the number of calculations performed increases, reducing the speed of rendering, which is undesirable.

To overcome the above problem, accordingly, there is interest in creating a 3D device to take into account the characteristics of 3D graphic data when rendering 3D graphic data by using a plurality of rendering functions with a smaller size than the single conventional rendering function so that they have a faster rendering speed.

However, when rendering of 3D graphic data is performed using the above-described plurality of rendering functions that are reduced in size, the rendering scene becomes complicated. Further, when the number of rendering functions increases, the number of calculations that need to be performed in order to generate the rendering functions also increases, thereby diminishing rendering performance.

### SUMMARY OF THE INVENTION

One or more embodiments of the present invention provide a method, medium, and system authoring 3D graphic data, capable of controlling the limiting of the number of rendering functions used during authoring of 3D graphic data.

Additional aspects and/or advantages of the invention will be set forth in part in the description which follows and, in part, will be apparent from the description, or may be learned by practice of the invention.

To achieve the above and/or other aspects and advantages, embodiments of the present invention include a method of authoring 3D (three-dimensional) graphic data, including generating a rendering function corresponding to characteristics of an authored object, and re-authoring the authored object to correspond to one of a stored plurality of rendering functions based on a determination of whether a total number of rendering functions, including the plurality of rendering functions and the generated rendering function, meets a predetermined limit.

To achieve the above and/or other aspects and advantages, embodiments of the present invention include a system authoring 3D graphic data, including a rendering function generator to generate a rendering function corresponding to characteristics of an authored object, a determiner to determine whether a total number of rendering functions, including a plurality of stored rendering functions and the generated rendering function, meets a predetermined limit, and an outputter to request a re-authoring of the authored object to correspond to one of the plurality of rendering functions, according to a result of the determiner.

To achieve the above and/or other aspects and advantages, embodiments of the present invention include a system authoring 3D graphic data, including a rendering function generator to generate a rendering function corresponding to characteristics of an authored object, a memory to store the generated rendering function, a determiner to determine whether a total number of rendering functions stored in the memory meets a predetermined limit, and an object reviser searching for a rendering function, from among the rendering functions stored in the memory, that is closest to the generated rendering function corresponding to the characteristics of the authored object when the total number of rendering functions stored in the memory is determined to meet the predetermined limit, and revising the characteristics of the authored object to correspond to a corresponding found rendering function resulting from the searching for the rendering function.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a system authoring 3D graphic data, according to an embodiment of the present invention;

FIG. 2A is a table illustrating an example of code blocks for vertex processing, according to an embodiment of the present invention;

FIG. 2B is a table illustrating an example of code blocks for pixel processing, according to an embodiment of the present invention;

FIG. 3 illustrates examples of rendering functions that may be generated by a rendering function generator, such as that illustrated in FIG. 1, according to an embodiment of the present invention;

FIG. 4 illustrates a method of authoring 3D graphic data, according to an embodiment of the present invention;

FIG. 5 illustrates a method of authoring 3D graphic data, according to another embodiment of the present invention; and

FIG. 6 illustrates an example of 3D graphic data for explaining the 3D graphic data authoring method, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

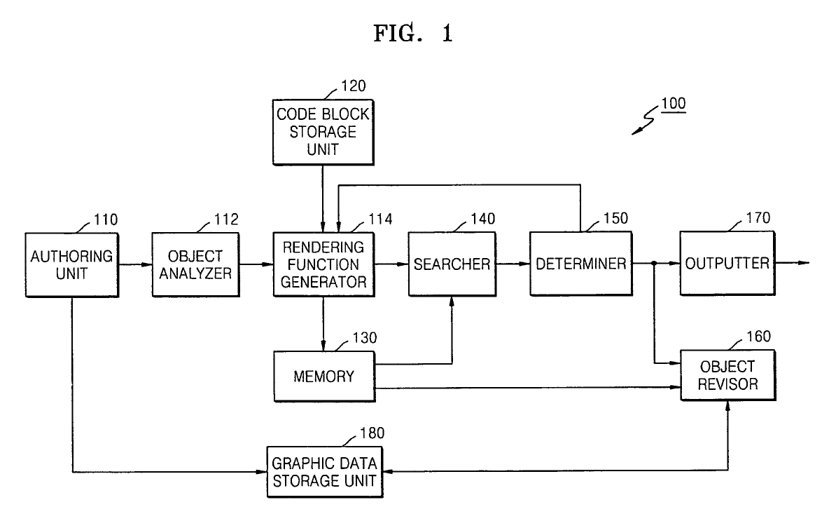

FIG. 1 illustrates a 3D graphic data authoring system 100, according to an embodiment of the present invention.

Referring to FIG. 1, the 3D graphic data authoring system 100 may include an authoring unit 110, an object analyzer 112, a rendering function generator 114, a code block storage unit 120, a memory 130, a searcher 140, a determiner 150, an object reviser 160, an outputter 170, and a graphic data storage unit 180, for example. In an embodiment, the 3D graphic data authoring system 100 may use a program such as 3 ds, 3 ds max, or Maya for performing authoring by receiving inputs from a user.

The authoring unit 110 may receive inputs from a user, for example, on data for objects that form 3D graphic data to author the objects. For example, when a user inputs commands for data on an object through a user interface (not shown) of the system 100, the authoring unit 110 may author the object according to the commands.

The object analyzer 112 may receive data on the authored object, and analyze the characteristics of the object. The data input to the object analyzer 110 generally includes vertex characteristic data, primitive characteristic data (which is an assemblage of vertices), and rendering state data relating to vertex processing and pixel processing.

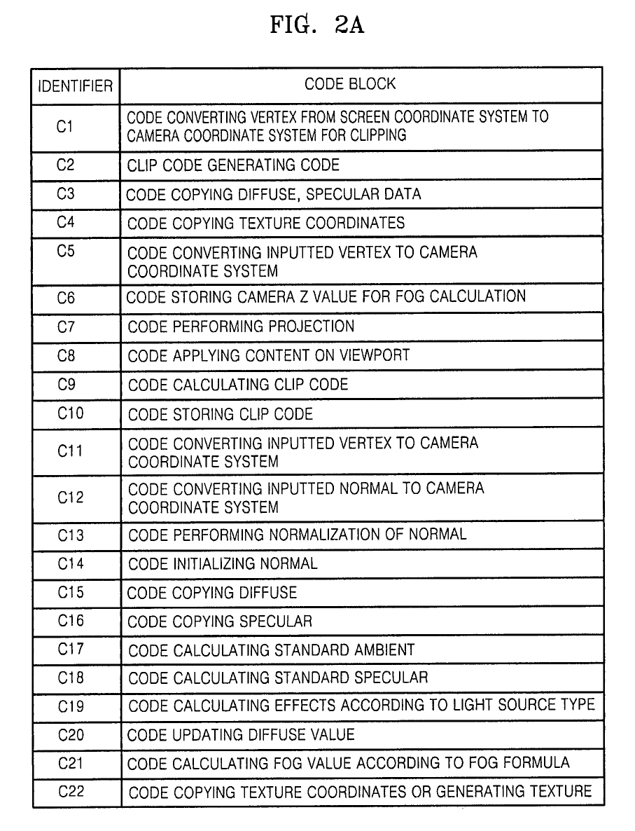

The code block storage unit 120 may store code blocks formed by codes that perform predetermined functions. Examples of code blocks are illustrated in FIGS. 2A and 2B. FIG. 2A is a table illustrating an example of code blocks for vertex processing, and FIG. 2B is a table illustrating an example of code blocks for pixel processing. Examples of each code block are bundles of commands for converting vertices from a screen coordinate system to a camera coordinate system for clipping, or bundles of commands for generating clip codes.

The contents of each code block illustrated in FIGS. 2A and 2B are merely examples for code blocks required to perform vertex processing and pixel processing, noting that alternative examples are equally available. Accordingly, these code blocks are only exemplary, and thus, detailed descriptions of each code block will not be further provided.

The rendering function generator 114 may be based on the characteristic data of the objects analyzed by the object analyzer 112, read code blocks corresponding to the characteristic data from the code block storage unit 120, combine the read code blocks, and generate a rendering function corresponding to the characteristics of the authored objects. A plurality of objects may be included in 3D graphic data. Thus, the rendering function generator 114 may generate a rendering function corresponding to the characteristics of authored objects when the authoring unit 110 authors each object in the 3D graphic data authoring process.

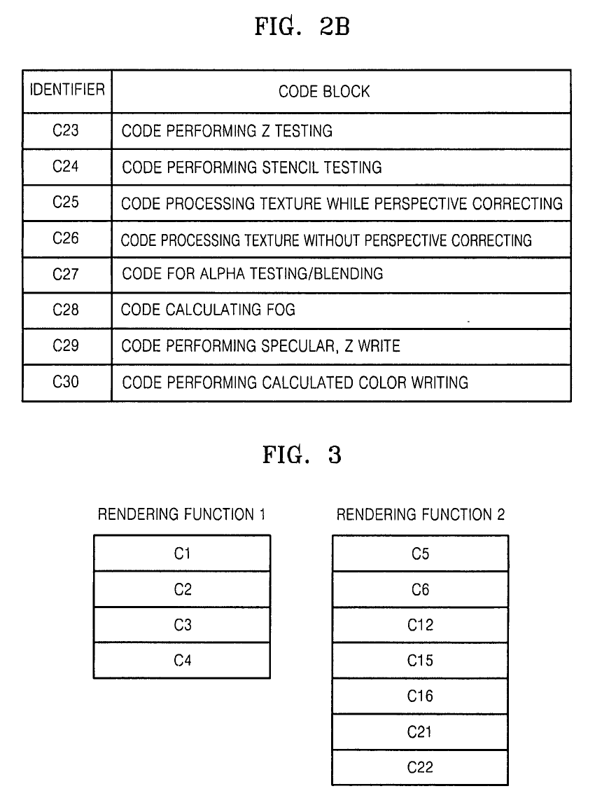

FIG. 3 illustrates examples of rendering functions that may be generated by such a rendering function generator 114 as illustrated in FIG. 1. Referring to FIG. 3, rendering function 1 is formed of code blocks C1, C2, C3, and C4, and rendering function 2 is formed of code blocks C5, C6, C12, C15, C16, C21, and C22.

The rendering function generator 114 may store the generated rendering functions in the memory 130, for example. However, the rendering functions corresponding to each object are not always stored whenever they are generated. Here, because different objects may have the same or substantially similar characteristics and therefore the same or substantially similar corresponding rendering function, when a generated rendering function is the same or substantially similar as one that already exists, e.g., in the memory 130, there is no need to store the generated rendering functions in the memory 130. This same or substantial similarity corresponds to the already stored rendering function being capable of use for rendering the same or similar to the generated rendering function sufficiently to a users preference. Accordingly, in an embodiment, the rendering function generator 114 may respond to a control signal output by the determiner 150, and store a generated rendering function in the memory 130 when the generated memory function does not already exist in the memory 130 and the number of rendering functions stored in the memory 130 does not exceed a predetermined number.

Here, the searcher 140 may search for rendering functions in the memory 130 that are the same or substantially similar to the rendering functions generated by the rendering function generator 114. When it is determined that the rendering functions existing in the memory 130 are not the same or substantially similar to a generated rendering function, a control signal may be output to the determiner 150.

When the determiner 150 receives such a control signal from the searcher 140, it may be further determined whether the number of rendering functions in the memory 130 exceeds a predetermined number. Here, the predetermined number may be a value that is determined according to the characteristics of the rendering engine for reproducing 3D graphic data currently being authored, and may be designated to be a maximum allowable number of rendering functions that will not impede the reproducing performance of the rendering engine. However, the predetermined number/limit is a value that may be variably determined based on a required reproduction quality.

When it is determined that the number of rendering functions in the memory 130 does not exceed the predetermined number, the determiner 130 may output a corresponding control signal to the rendering function generator 114. However, when it is determined that the number of rendering functions in the memory 130 exceeds the predetermined number, the determiner 130 may output a corresponding control signal to the object reviser 160 or the outputter 170.

When the object reviser 160 receives such a control signal from the determiner 130, a rendering function, from among the rendering functions stored in the memory 130, that is the closest to a rendering function generated by the rendering function generator 114 may be searched for, the characteristics of the objects authored by the authoring unit 110 may be revised to correspond to the corresponding object of the found rendering function, and the revised objects are stored in the graphic data storage unit 180. In further detail, here, the object reviser 160 may search for a rendering function, from among the rendering functions stored in the memory 130, that overlaps the most in terms of code blocks with the rendering function generated by the rendering function generator 114. The object reviser 160 may thus transform a portion of the various characteristics possessed by the authored objects so that the characteristics of the authored objects correspond to the functions performed by each code block included in a corresponding found rendering function.

The outputter 170 may receive a corresponding control signal from the determiner 130, output a message notifying a user, for example, that the number of rendering functions required to reproduce the currently authored 3D graphic data exceeds the predetermined number, and request a re-authoring of the objects. Here, in an embodiment, a user may search for objects, from among the previously authored objects, that are the closest to the current authored objects, and re-edit the authored objects to match the characteristics of the corresponding found object(s).

In an embodiment, the 3D graphic data authoring system illustrated in FIG. 1 may selectively include the object reviser 160 and the outputter 170. That is, the system may include only one of the object reviser 160 and the outputter 170. Furthermore, by including both the object reviser 160 and the outputter 170, a user, for example, may be able to both re-edit objects according to the requirements of the outputter 170 and edit the characteristics of the objects authored by the object reviser 160. Alternate embodiments are equally available.

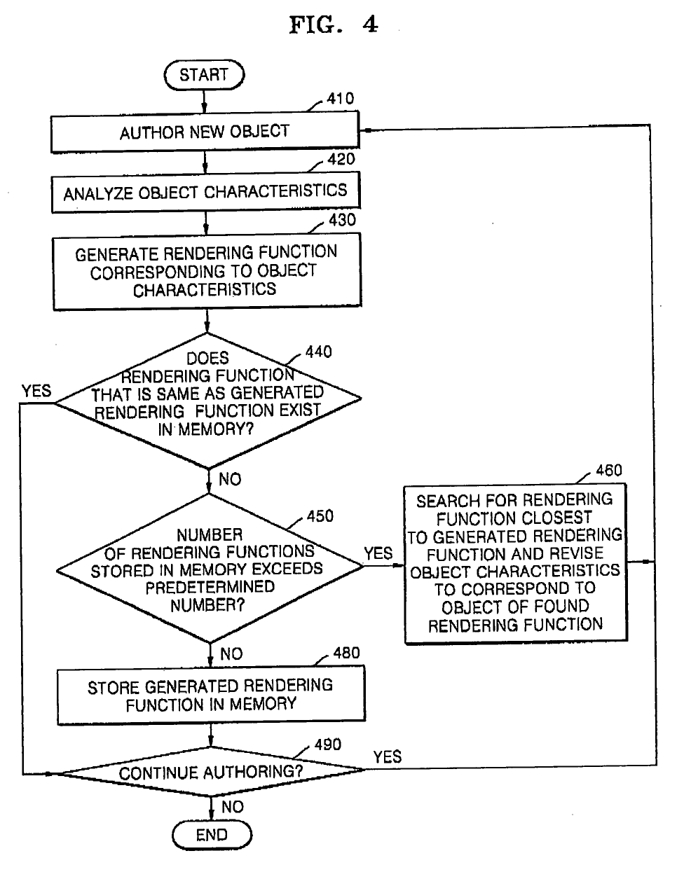

FIG. 4 illustrates a method of authoring 3D graphic data, according to an embodiment of the present invention. Below, the described method may be performed by the 3D graphic data authoring system 100 of FIG. 1, for example, but embodiments are not limited thereto.

In operation 410, command inputs may be received from a user, for example, on data for forming 3D graphic data, and objects may be authored.

In operation 420, the characteristics of the authored objects may be analyzed.

In operation 430, code blocks corresponding to the characteristic data of the analyzed objects may be read, e.g., from the code block storage unit 120, the read code blocks may be combined, and a rendering function corresponding to the characteristics of the authored objects may be generated.

In operation 440, the memory 130, for example, may be searched to determine whether there is a rendering function in the memory that is the same or substantially similar to the generated memory function. Here, when it is determined that a rendering function that is the same or substantially similar to the generated rendering function already exists, operation 490 may be performed. If it is determined that there is no rendering function in the memory that is the same or substantially similar to the generated rendering function, operation 450 may be performed.

In operation 490, it may be determined whether the user, for example, wants to continue authoring the 3D graphic data, and performs operation 410 if it is determined that the authoring is to be continued.

In operation 450, it may be determined whether the number of rendering functions stored in the memory 130, for example, exceeds a predetermined number. Here, when it is determined that the number of rendering functions exceeds the predetermined number, operation 460 may be performed. If it is determined that the number of stored rendering functions does not exceed the predetermined number, operation 480 may be performed.

In operation 480, the generated rendering function may be stored, e.g., in the memory 130. As a result, the generated rendering function may be stored when the generated rendering function does not already exist, e.g., in the memory 130, and the number of stored rendering functions does not exceed the predetermined number.

In operation 460, a rendering function may be searched for, from among the stored rendering functions, that is the closest to the generated rendering function, and characteristics of the authored object may be revised to correspond to the corresponding found rendering function.

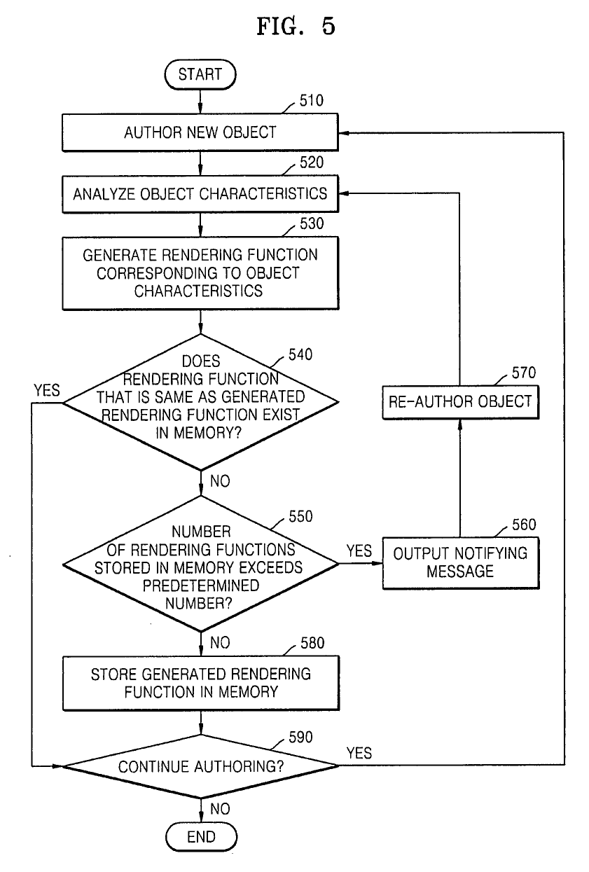

FIG. 5 illustrates a method of authoring 3D graphic data, according to another embodiment of the present invention. Below, the described method may be performed by the 3D graphic data authoring system 100 of FIG. 1, for example, but embodiments are not limited thereto.

Operations 510 through 540, 580, and 590 may be respectively similar to operations 410 through 440, 480, and 490 in FIG. 4, for example, and therefore further description thereof will not be repeated.

In operation 550, it may be determined whether the number of stored rendering functions, e.g., stored in the memory 130, exceeds a predetermined number. Here, when it is determined that the number of stored rendering functions exceeds the predetermined number, operation 560 may be performed. If it is determined that the number of stored rendering functions does not exceed the predetermined number, operation 580 may be performed.

In operation 560, a message notifying a user, for example, that the number of rendering functions required to reproduce the 3D graphic data being authored exceeds the predetermined number may be output, and a re-authoring of objects may be requested.

In operation 570, when the user, for example, re-authors the objects, operation 520 may again be performed, and the characteristics of the re-authored objects may be analyzed.

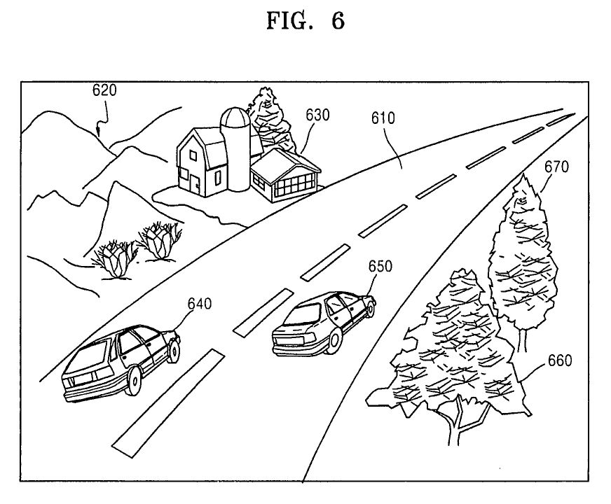

FIG. 6 illustrates an example of 3D graphic data for explaining a 3D graphic data authoring method, according to an embodiment of the present invention. Here, the example objects include a road 610, grass 620, a house 630, a first car 640, a second car 650, a first tree 660, and a second tree 670. Below, the described method may be performed by the 3D graphic data authoring system 100 of FIG. 1, for example, but embodiments are not limited thereto.

For only the sake of convenience, the maximum allowable number of rendering functions may be set at 5, so as to prevent a reduction in performance of a rendering engine that reproduces 3D graphics. In addition, the first car 640 and the second car 650 may be considered to have the same or substantially similar corresponding rendering function, and the first tree 660 and the second tree 670, while not having the same or substantially similar corresponding rendering function, may be considered to be the closest rendering functions compared to other objects.

First, when the authoring unit 110 authors the road 610 object, the rendering function generator 114 may generate a rendering function corresponding to the road 610 object and store it in the memory 130, for example. Similarly, when the authoring unit 110 authors the grass 620 object, the house 630 object, the first car 640 object, etc., the rendering function generator 114 may generate rendering functions corresponding to the respective objects and store them in the memory 130. Thus, four rendering functions may be stored in the memory.

When the authoring unit 110 authors the second car 650 object, the rendering function generator 114 may generate a rendering function corresponding to the second car 650 object. The searcher 140 may determine whether there is a rendering function in the memory 130 that is the same or substantially similar to the rendering function corresponding to the second car 650 object. Since there already is a rendering function stored in the memory that is the same or substantially similar to the rendering function corresponding to the second car 650 object, the rendering function generator 114 does not need to store the rendering function corresponding to the second car 650 object in the memory 130.

When the authoring unit 110 authors the first tree 660 object, the rendering function generator 114 may generate a rendering function corresponding to the first tree 660 object. The searcher 140 may search the memory 130 for a rendering function that is the same or substantially similar to a rendering function corresponding to the first tree 660 object. Since there is no rendering function stored in the memory 130 that is the same or substantially similar to a rendering function corresponding to the first tree 660 object, the determiner 150 determines whether there are 5 rendering functions stored in the memory 130. Since there are currently 4 (and not 5 or more) rendering functions stored in the memory 130, the rendering function generator 114 may store the rendering function corresponding to the first tree 660 object in the memory 130.

The authoring unit 110 may further author the second tree 670 object, and the rendering function generator 114 may generate a rendering function corresponding to the second tree 670 object. The searcher 140 may determine whether there is a rendering function that exists in the memory 130 that is the same or substantially similar to a rendering function corresponding to the second tree 670 object. Since there is no rendering function in the memory 130 that is the same or substantially similar to the rendering function corresponding to the second tree 670 object, the determiner 150 may determine whether there are 5 or more rendering functions stored in the memory 130. Since there are 5 rendering functions currently stored in the memory 130, the object reviser 160 searches for a rendering function from the rendering functions stored in the memory 130 that is closest to a rendering function corresponding to the second tree 670 object, and revises the searched for rendering function to reflect the characteristics of the second tree 670 object. In this case, the corresponding found rendering function, from among those stored in the memory 130, that is closest to the rendering function corresponding to the second tree 670 object is the rendering function corresponding to the first tree 660 object. Thus, the object reviser 160 may revise the characteristics of the second tree 670 object to correspond to the rendering function corresponding to the first tree object 660.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

According to the present invention, rendering functions corresponding to the characteristics of authored objects are generated, and when it is determined that the number of rendering functions exceeds a predetermined number, the objects are authored differently, so that the number of rendering functions used during reproduction of authored 3D graphic data can be limited. Accordingly, when 3D graphic data is reproduced, a reduction in rendering performance during the authoring phase can be prevented.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of authoring 3D (three-dimensional) graphic data, comprising:
generating a rendering function corresponding to characteristics of an authored object; and
re-authoring the authored object to correspond to one of a stored plurality of rendering functions based on a determination of whether a total number of rendering functions, including the plurality of rendering functions and the generated rendering function, meets a predetermined limit.

2. The method of claim 1, wherein the generated rendering function is formed of a combination of code blocks that are units performing predetermined functions corresponding to the characteristics of the authored object.

3. The method of claim 1, wherein the generating of the rendering function comprises generating the rendering function by combining code blocks that are units performing predetermined functions corresponding to the characteristics of the authored object based on results of an analyzing of the characteristics of the authored object.

4. The method of claim 1, further comprising storing the generated rendering function in a memory storing the plurality of rendering functions, wherein the determining of whether the total number of rendering functions meets the predetermined limit comprises determining whether a number of the plurality of rendering functions stored in the memory meets the predetermined limit.

5. The method of claim 4, wherein the determining of whether the total number of rendering functions meets the predetermined limit is performed upon a determination that the generated rendering function does not exist in the memory, and the storing of the generated rendering function in the memory comprises storing the generated rendering function in the memory upon the determination that the number of the plurality of rendering functions stored in the memory does not meet the predetermined limit.

6. The method of claim 1, wherein the re-authoring of the object is performed according to inputs of a user, when the total number of rendering functions is determined to meet the predetermined limit.

7. The method of claim 4, wherein the re-authoring of the object comprises:
searching for a rendering function, from among the plurality of rendering functions stored in the memory, that is closest to the generated rendering function corresponding to characteristics of the authored object, when the total number of rendering functions is determined to meet the predetermined limit; and
re-authoring the authored object through revising the characteristics of the authored object to correspond to a corresponding found rendering function resulting from the searching for the rendering function.

8. At least one medium comprising computer readable code to control at least one processing element to implement the method of claim 1.

9. A system authoring 3D graphic data, comprising:
a rendering function generator to generate a rendering function corresponding to characteristics of an authored object;
a determiner to determine whether a total number of rendering functions, including a plurality of stored rendering functions and the generated rendering function, meets a predetermined limit; and
an outputter to request a re-authoring of the authored object to correspond to one of the plurality of rendering functions, according to a result of the determiner.

10. The system of claim 9, wherein the generated rendering function is formed of a combination of code blocks that are units performing predetermined functions corresponding to the characteristics of the authored object.

11. The system of claim 9, further comprising an object analyzer to analyze the characteristics of the authored object, wherein the rendering function generator generates the generated rendering function by combining code blocks that are units performing predetermined functions corresponding to the characteristics of the authored object based on a result of the analyzer.

12. The system of claim 9, further comprising a memory storing the plurality of rendered functions and to store the generated rendering function, wherein the determiner determines whether a number of the plurality of rendering functions stored in the memory meets the predetermined limit.

13. The system of claim 12, wherein the determiner determines whether the total of the rendering functions meets the predetermined limit, upon a determination that the generated rendering function does not exist in the memory, and the rendering function generator stores the generated rendering function in the memory upon the determination that the number of the plurality of rendering functions stored in the memory does not meet the predetermined limit.

14. A system authoring 3D graphic data, comprising:
a rendering function generator to generate a rendering function corresponding to characteristics of an authored object;
a memory to store the generated rendering function;
a determiner to determine whether a total number of rendering functions stored in the memory meets a predetermined limit; and
an object reviser searching for a rendering function, from among the rendering functions stored in the memory, that is closest to the generated rendering function corresponding to the characteristics of the authored object when the total number of rendering functions stored in the memory is determined to meet the predetermined limit, and revising the characteristics of the authored object to correspond to a corresponding found rendering function resulting from the searching for the rendering function.

15. The system of claim 14, wherein the determiner determines whether the number of rendering functions stored in the memory meets the predetermined limit upon a determination that the generated rendering function does not exist in the memory, and the rendering function generator stores the generated rendering function in the memory upon the determination that the number of rendering functions stored in the memory does not meet the predetermined limit.

16. The system of claim 14, wherein the generated rendering function is formed of a combination of code blocks that are units performing predetermined functions corresponding to the characteristics of the authored object.

17. The system of claim 14, further comprising an object analyzer to analyze the characteristics of the authored object, wherein the rendering function generator generates the generated rendering function by combining code blocks that are units performing predetermined functions corresponding to the characteristics of the authored object based on a result of the analyzer.
